(19) United States
(12) Patent Application Publication
(10) Pub. No.: US 2025/0329950 A1
(43) Pub. Date: Oct. 23, 2025

(54) Printed Circuit Board Plug Connector, Printed Circuit Board Assembly and Method for Assembling a Printed Circuit Board Plug Connector

(71) Applicant: ROSENBERGER HOCHFREQUENZTECHNIK GMBH & CO. KG, Fridolfing (DE)

(72) Inventors: Markus Schichl, Fridolfing (DE); Simon Huber, Fridolfing (DE); Johannes Julian Posselt, Fridolfing (DE)

(21) Appl. No.: 19/183,037

(22) Filed: Apr. 18, 2025

(30) Foreign Application Priority Data
Apr. 19, 2024 (EP) 24171323.9

(51) Int. Cl. H01R 12/71; H01R 12/75

(52) U.S. Cl. CPC H01R 12/716; H01R 12/75

(57) ABSTRACT

The invention relates to a printed circuit board plug connector with a first interface for electrical and mechanical connection to an electrical printed circuit board, having an electrically conductive outer housing, an electrically insulating contact carrier for at least one electrical contact element, which contact carrier is accommodated at least in portions in the outer housing, and at least one outer conductor connection element fastened to the contact carrier. For electrical and mechanical connection to the electrical printed circuit board, the outer conductor connection element has at least one first contacting portion arranged in the first interface and at least one second contacting portion, which is elastic in the lateral direction (y), for electrical and mechanical contacting of an inner lateral surface of the outer housing.

The invention relates to a printed circuit board plug connector with a first interface for electrical and mechanical connection to an electrical printed circuit board, comprising an electrically conductive outer housing, an electrically insulating contact carrier and at least one outer conductor connection element, as disclosed herein.

The invention also relates to a printed circuit board assembly comprising an electrical printed circuit board and a printed circuit board plug connector electrically and mechanically connected to the printed circuit board.

The invention also relates to a method for assembling a printed circuit board plug connector designed for electrical and mechanical connection to an electrical printed circuit board.

Printed circuit board plug connectors are used to establish electrical connections with at least one electrical printed circuit board (PCB) in order to enable the exchange of data and energy between the printed circuit board and one or more other electrical assemblies. A printed circuit board plug connector can be used, for example, to connect an electrical cable to the electrical printed circuit board or to connect another electrical printed circuit board or another electrical assembly directly to the electrical printed circuit board.

In high-frequency technology in particular, it is sometimes crucial to ensure electromagnetically shielded signal transmission. This requires a reliable earth or shielding transfer between the electrical printed circuit board and the printed circuit board plug connector. Printed circuit board plug connectors often have a metal outer housing for shielding, which can be connected to an earth connection on the electrical printed circuit board. A dielectric contact carrier is usually arranged inside the outer housing to accommodate at least one electrical contact element.

As an example of a shield attachment of a printed circuit board plug connector, reference is made to U.S. Pat. No. 10,439,335 B2, for example, which proposes an end-face shield attachment that is elastic in the axial direction. For this purpose, an elastic connection element separate from the outer housing is provided, which in turn connects a separate, pin-shaped earth contact to the outer housing.

The known outer conductor attachments are generally complex to manufacture and assemble and are therefore problematic, particularly with regard to the economic manufacturability of the printed circuit board plug connector in the context of mass production. There is thus a need for alternative ways of attaching the outer conductor or shield of a printed circuit board plug connector.

In view of the known prior art, the object of the present invention is to provide a printed circuit board plug connector which enables a reliable and preferably easy to manufacture and install outer conductor attachment to the electrical printed circuit board.

An additional object of the present invention is to provide a printed circuit board assembly formed of an electrical printed circuit board and a printed circuit board plug connector which enables a reliable outer conductor attachment to the electrical printed circuit board which is preferably easy to manufacture and assemble.

An additional object of the invention is to provide a method for assembling a printed circuit board plug connector in order to manufacture a printed circuit board plug connector with a reliable outer conductor attachment, preferably simply and economically.

The object is achieved for the printed circuit board plug connector with the features disclosed herein. With regard to the printed circuit board assembly, the object is achieved by the features disclosed herein, and for the method for assembling the printed circuit board plug connector disclosed herein.

The features described below relate to advantageous embodiments and variants of the invention.

The invention relates to a printed circuit board plug connector with a first interface for electrical and mechanical connection to an electrical printed circuit board.

The invention can be particularly advantageously, but not exclusively, suitable for use with circular plug connectors, such as an M8, M12, M23 or other circular plug connectors. In principle, however, the printed circuit board plug connector and its plug connector components can have any geometry or cross-section.

The printed circuit board plug connector can be designed as any type of plug connector. For example, the invention can be provided for single-pole or multi-pole printed circuit board plug connectors. The printed circuit board plug connector is described below in essence as a multi-pole plug connector, but this is not to be understood as restrictive—the printed circuit board plug connector can also be a single-pole, coaxial plug connector, for example.

The printed circuit board plug connector can be designed for electrical data transmission and/or electrical power transmission. Preferably, it is a printed circuit board plug connector for high-frequency technology, for the transmission of electrical data at high data rates.

Said “first interface” is preferably designed for a direct connection to the electrical printed circuit board.

Preferably, the first interface is arranged at a first end of the printed circuit board plug connector.

The first interface can have optional mechanical connection means, such as latching elements for latching with mating latching elements of the electrical printed circuit board, mechanical coding means for ensuring a defined alignment or orientation of the printed circuit board plug connector relative to the electrical printed circuit board, locking elements for blocking the movement of the printed circuit board plug connector connected to the printed circuit board in at least one degree of freedom (e.g. a centring pin that can be inserted into a receptacle of the printed circuit board), insertion and positioning means and/or spacers or feet. The invention is suitable for use with any type of interface.

According to the invention, the printed circuit board plug connector has an electrically conductive outer housing.

The electrically conductive outer housing is preferably a metal outer housing, particularly preferably a die-cast part or turned part made of metal.

The outer housing can have one or more mechanical interfaces to connect the printed circuit board plug connector to the electrical printed circuit board, an assembly housing surrounding the electrical printed circuit board, an electrical cable or another electrical device. The mechanical interface can, for example, be a screw connection (e.g. an external thread of the outer housing for connection to a screw nut or another sleeve-shaped screw element with an internal thread). In principle, the invention can be suitable for use with any outer housing and is not to be understood as being limited to a specific design.

Preferably, the outer housing is at least substantially sleeve-shaped or cylindrical and is designed to provide electromagnetic shielding for the printed circuit board plug connector.

It should be mentioned at this point that the term “outer housing” is not intended to exclude the possibility that one or more further housing elements of the printed circuit board plug connector may also be provided around the “outer housing”, irrespective of whether these are electrically conductive or electrically insulating. For example, an insulating housing surrounding the outer housing may be provided to ensure protection against contact.

The outer housing can also be made in a plurality of parts (for example, from two housing shells that can be joined together). Preferably, however, a single-piece or one-piece outer housing is provided.

According to the invention, the printed circuit board plug connector also has an electrically insulating contact carrier for at least one electrical contact element, which contact carrier is accommodated at least in portions in the outer housing.

The electrically insulating contact carrier is preferably accommodated at least substantially in the outer housing, in particular in a through-hole or other feed-through in the outer housing.

It may be provided that the contact carrier is held captively in the outer housing, preferably is fixed in the outer housing in a form-fitting, frictionally engaged and/or integrally bonded manner. In particular, the outer housing can have one or more axial stops to enable axial movement of the contact carrier to be limited. For example, the contact carrier can have one or more elevations on the outer lateral surface side, such as a fully circumferential fastening flange, a circumferential step or another protrusion on the outer lateral surface side.

Optionally, one or more sealing elements, for example sealing rings, can be provided between the outer housing and the contact carrier to prevent the penetration of fluids and/or contamination into the interior of the printed circuit board plug connector.

The contact carrier is preferably used to fasten the electrical contact elements of the printed circuit board plug connector and can, for example, have one or more contact chambers for holding one or more contact elements (preferably exactly one contact chamber per contact element). Preferably, the contact chambers run completely through the contact carrier so that contact can be made on both sides of the contact element held in the contact carrier.

Optionally, shielding plates (e.g. a shielding star) can be provided in the contact carrier to shield the individual contact elements.

The at least one electrical contact element can be fixed in the contact carrier (in particular within said contact chamber). Preferably, the electrical contact element can be locked in the contact carrier at least in the axial direction, for example by a step or a latching hook in the corresponding contact chamber, by a press connection between the contact chamber and the contact element or by another fastening technique.

In principle, the electrical contact element can be of any design and can also be referred to as an “inner conductor contact element”. The electrical contact element can, for example, be designed as a stamped and bent part or a turned part.

In particular, it may be provided that the electrical contact element extends into the first interface of the printed circuit board plug connector and is designed in the region of the first interface for electrical and mechanical connection to the electrical printed circuit board. For this purpose, the electrical contact element can, for example, be designed at least in the region of the first interface as a contact pin for a press and/or solder connection with the electrical printed circuit board, wherein in principle any connection techniques can be provided for connection with the electrical printed circuit board in the region of the first interface.

According to the invention, the printed circuit board plug connector has at least one outer conductor connection element fastened to the contact carrier.

The outer conductor connection element is preferably a component that is independent of the contact carrier and the outer housing.

According to the invention, it is provided that the outer conductor connection element has at least one first contacting portion arranged in the first interface for electrical and mechanical connection to the electrical printed circuit board.

Said “first contacting portion” of the outer conductor connection element can, for example, be designed as a contact pin, for example as a contact pin for a press connection (e.g. “press fit”) and/or solder connection with the electrical printed circuit board. In principle, however, any connection technology can be provided for connection to the electrical printed circuit board. For example, the first contacting portion of the outer conductor connection element can also be designed as an SMD solder contact (this can also apply to the electrical contact element as an alternative or supplement).

Preferably, the first contacting portion is set up for a direct electrical and mechanical connection with the electrical printed circuit board.

According to the invention, the outer conductor connection element has at least one second contacting portion, which is elastic in the lateral direction, for making electrical and mechanical contact with an inner lateral surface of the outer housing.

The outer conductor connection element can therefore be used advantageously to establish an earth or outer conductor connection between the electrical printed circuit board and the outer housing of the printed circuit board plug connector. Preferably, the outer conductor connection element is connected directly to the electrical printed circuit board and directly to the outer housing of the printed circuit board plug connector for this purpose.

Preferably, the first contacting portion and the second contacting portion are arranged at a distance from each other and particularly preferably in the region of different (in particular opposite) end portions of the outer conductor connection element.

The outer conductor connection element is preferably a one-piece component, in particular a stamped and bent part. In principle, however, the outer conductor connection element can also be made in a plurality of parts (less preferred). Any manufacturing process may also be suitable for forming the outer conductor connection element.

The fact that the outer conductor connection element is a one-piece component that creates a connection (usually at the front) to the electrical printed circuit board on the one hand and a lateral or radial connection to the outer housing of the printed circuit board plug connector on the other means that the outer conductor connection element, and therefore also the printed circuit board plug connector itself, can be easily manufactured and assembled. The elasticity of the second contacting portion can also enable vibration-stable and tolerance-compensating contacting.

In an advantageous development of the invention, it can be provided that the at least one outer conductor connection element is accommodated at least in portions in a recess in the contact carrier.

The recess in question is preferably a laterally accessible recess, for example an elongate recess running in the axial direction (e.g. a fastening groove), within an outer lateral surface of the contact carrier.

In this way, the outer conductor connection element can be particularly easily connected to the contact carrier or mounted on the contact carrier. For example, the outer conductor connection element can be mounted directly laterally or in the radial direction (mounting in the axial direction, starting from the first interface, is generally preferred, however).

The second contacting portion of the outer conductor connection element can be optimally accessed for contacting with the inner lateral surface of the outer housing through a laterally accessible recess.

It should be mentioned at this point that a recess in the contact carrier to accommodate the outer conductor connection element is not absolutely necessary. In principle, the outer conductor connection element can also be fastened directly to or on the outer lateral surface of the contact carrier, for example by using latching elements or the like arranged on the outer lateral surface.

Preferably, however, the outer conductor connection element is accommodated in said recess at least in the region of the second contacting portion, in particular in such a way that the second contacting portion projects laterally out of the recess for contacting the outer housing at least in the mechanically relaxed state of the outer conductor connection element.

According to a development of the invention, it can be provided that the at least one outer conductor connection element has at least one fastening clamp, with which the outer conductor connection element is fastened to the contact carrier in a frictionally engaged manner. The fastening clamp is preferably spaced apart from the first contacting portion and the second contacting portion, but may also be formed in one or both of said contacting portions.

The at least one fastening clamp is preferably arranged between the first contacting portion and the second contacting portion (in particular in a central axial portion of the outer conductor connection element).

The fastening clamp can have one or more elastic fastening fingers for direct fastening to the contact carrier. The fastening fingers and/or the fastening clamp can preferably have a U-shaped cross-sectional profile.

According to a development of the invention, it can be provided that the at least one fastening clamp clamps around a lateral elevation of the contact carrier in a laterally frictionally engaged manner.

Said lateral elevation of the contact carrier can be, for example, a mounting flange, a mounting web or a mounting rib on the outer lateral surface of the contact carrier.

In its assembled state, the at least one fastening clamp can thus be spread open against an elastic restoring force starting from a mechanically relaxed state, which can cause the frictionally engaged fastening to the contact carrier. It should be mentioned at this point that the described spreading of the fastening clamp preferably does not cause any plastic deformation, wherein in special cases additional or possibly even exclusively plastic deformation of the fastening clamp may be provided for mounting on the contact carrier.

Alternatively or in addition to a frictionally engaged connection, a form-fitting connection or at least one movement limitation can be provided in at least one degree of freedom between the fastening clamp and the contact carrier. For example, the lateral elevation can have an indentation to accommodate the fastening clamp.

According to a development of the invention, it can also be provided that the at least one fastening clamp is inserted in a recess in the contact carrier in a frictionally engaged manner, preferably in a laterally accessible fastening groove within an outer lateral surface of the contact carrier.

In its mounted state in the recess, the fastening clamp can thus be compressed or “squeezed” against an elastic restoring force, starting from a mechanically relaxed state, which can cause the frictionally engaged fastening to or in the contact carrier. For this purpose, the fastening clamp can be supported in a frictionally engaged manner in particular on opposite walls of said recess. Optional movement limitations or a form fit can also be provided for this variant.

In a development of the invention, it may be provided that the at least one outer conductor connection element and the contact carrier form one or more latching connections for mutual latching.

For example, it may be provided that the outer conductor connection element, in particular in a central axial portion between the first contacting portion and the second contacting portion (but possibly also in at least one of the contacting portions), has a latching element, such as projections and/or recesses, which are able to latch into corresponding mating latching elements of the contact carrier.

In particular, the latching connection can be set up to ensure that the outer conductor connection element is secured in the axial direction, as securing in the lateral direction is usually already ensured by the mounted outer housing. Optionally, however, the latching connection can also be provided for securing in the lateral direction (for example, to ensure sufficient security against loss if the outer conductor connection element is already pre-assembled in a delivery state of the printed circuit board plug connector).

In an advantageous development of the invention, it can be provided that the second contacting portion of the outer conductor connection element has at least one spring tab that is elastic in the lateral direction.

The second contacting portion, in particular said spring tab, can be designed to make point contact (preferably) or line contact with the inner lateral surface of the outer housing. The spring tab can be bent for this purpose. For example, the spring tab can have a bend to form a line contact or a convex curvature to provide a point contact.

It should be mentioned at this point that, in principle, a planar contact or a flat contact can also be provided for contacting the inner lateral surface of the outer housing (less preferred).

In a particularly advantageous development of the invention, it can be provided that a free end of the spring tab is bent pointing away from the inner lateral surface of the outer housing.

In this way, the spring tab is able to make contact with the inner lateral surface of the outer housing in the assembled state not with the free end, but with a contact region at a distance from the free end.

The bent free end of the spring tab can simplify the assembly of the outer housing and also ensure that the outer conductor connection element is not damaged during assembly by the spring tab unintentionally hooking onto the outer housing with its free end and subsequently being bent.

In an advantageous development of the invention, it can be provided that a plurality of the outer conductor connection elements are arranged distributed along the circumference of the contact carrier.

Any number of outer conductor connection elements can be provided as part of the printed circuit board plug connector according to the invention. However, a single outer conductor connection element may also be sufficient. Preferably, at least two spaced-apart outer conductor connection elements are arranged distributed along the circumference of the contact carrier, but also, for example, three, four, five, six or even more outer conductor connection elements. By providing a corresponding redundancy in the outer conductor connection, the outer conductor contact or the shield transfer can be electrically improved and also designed to be more tolerant and fail-safe.

Insofar as a plurality of outer conductor connection elements are distributed along the circumference of the contact carrier, these are preferably (but not necessarily) distributed equidistantly.

In a development of the invention, it can also be provided that the outer conductor connection element is arranged at least partially circumferentially along the circumference of the contact carrier.

The outer conductor connection element can, for example, be arranged around more than 180° of the circumference of the contact carrier, for example around more than 220°, around more than 260°, around more than 300° or around more than 340°. The outer conductor connection element can also be almost completely closed around the circumference of the contact carrier and in this case be slotted (in the manner of a sleeve slotted in the longitudinal direction). Insofar as the outer conductor connection element is arranged along the circumference of the contact carrier around more than 180°, it is preferably laterally and reversibly or elastically expandable for assembly.

However, the outer conductor connection element can also be mounted on the contact carrier starting from an axial direction.

In particular, the above-mentioned fastening clamp can be designed to encircle the contact carrier.

In a development of the invention, it may be provided that the printed circuit board plug connector has a second interface that is different from the first interface.

Said second interface can be designed for electrical and mechanical connection with a corresponding mating plug connector or with another electrical printed circuit board or other electrical assembly or with an electrical cable.

Said “second interface” is preferably designed for a direct connection with the mating plug connector, the additional printed circuit board, the electrical assembly or the electrical cable.

Preferably, the second interface is arranged at a second end of the printed circuit board plug connector that is different from the first end of the printed circuit board plug connector.

It should be mentioned at this point that the printed circuit board plug connector can be straight or angled (angled plug connector), wherein the centre axis in the angled case of the printed circuit board plug connector is bent between the first end or the first interface and the second end or the second interface (for example by) 90°.

The second interface can have optional mechanical connection means, as already described with regard to the first interface. The invention is suitable for use with any type of interface.

Preferably, the electrical contact elements accommodated in the contact carrier can be contacted starting from the second interface. The contact elements can, for example, be designed as socket or pin contacts in the second interface in order to contact corresponding mating contact elements of a mating plug connector. The contact elements can be detachably or permanently connectable to corresponding mating contact elements or electrical conductors of the mating part to be connected to the second interface (for example, the contact elements in the region of the second interface can be directly connectable to electrical conductors of an electrical cable).

The invention also relates to a printed circuit board assembly comprising an electrical printed circuit board and a printed circuit board plug connector according to the preceding and following embodiments, wherein the first interface of the printed circuit board plug connector is mechanically and electrically connected, preferably directly connected, to the electrical printed circuit board.

In an advantageous way, an earth or shield attachment can be made possible in the proposed printed circuit board assembly with technically simple measures to compensate for tolerances and vibrations by using the proposed outer conductor connection element. The proposed second contacting portion, in particular the correspondingly spring-loaded contact tabs or spring tabs, as described above, can be used to optimize shielding or earth transmission between the electrical printed circuit board and the outer housing. In particular, there is no need for expensive wave springs or similarly complex components or assemblies.

The invention also relates to a method for assembling a printed circuit board plug connector designed for electrical and mechanical connection to an electrical printed circuit board, said method comprising at least the following method steps:
providing an electrically insulating contact carrier for receiving at least one electrical contact element;
providing at least one outer conductor connection element, which has at least one first contacting portion for electrical and mechanical connection to the electrical printed circuit board, and fastening the outer conductor connection element to the contact carrier;
providing an outer housing and mounting the outer housing on the contact carrier so that at least a second contacting portion of the outer conductor connection element, which is elastic in the lateral direction, makes electrical and mechanical contact with an inner lateral surface of the outer housing.

It should be emphasized at this point that the method steps mentioned do not necessarily have to be carried out in the order in which they are first described or mentioned in the description. For example, individual method steps or groups of method steps may therefore be interchangeable with one another if this is not technically impossible. Method steps can also be combined with each other, divided into separate intermediate steps or supplemented with intermediate steps. The method is also not necessarily exhaustively described with the method steps described and can be supplemented with further method steps, including those not mentioned.

The proposed method makes the assembly of the printed circuit board plug connector or printed circuit board assembly easier and more economical overall.

Features which have been described in conjunction with one of the subjects of the invention, namely given by the printed circuit board plug connector according to the invention, the printed circuit board assembly according to the invention and the method according to the invention, can also be advantageously realized for the other subjects of the invention. Similarly, advantages mentioned in conjunction with one of the subjects of the invention can also be understood in relation to the other subjects of the invention.

In addition, it should be noted that terms such as “comprising”, “having” or “with” do not exclude other features or steps. Furthermore, terms such as “one” or “the”, which indicate a singular number of steps or features, do not exclude a plurality of features or steps-and vice versa.

It should be noted that designations such as “first” or “second” etc. are used primarily for reasons of differentiation of respective device or method features and are not necessarily intended to imply that features are mutually dependent or interrelated.

Furthermore, it should be emphasized that the values and parameters described herein include deviations or fluctuations of ±10% or less, preferably ±5% or less, more preferably ±1% or less, and very particularly preferably ±0.1% or less of the respective stated value or parameter, provided that these deviations are not excluded when the invention is implemented in practice. The specification of ranges by initial and final values also includes all those values and fractions which are included by the respectively stated range, in particular the initial and final values and a respective mean value.

The invention also relates to an outer conductor connection element for a printed circuit board plug connector, which has at least one first contacting portion for electrical and mechanical connection to an electrical printed circuit board, which can be arranged in a first interface of the printed circuit board plug connector for connection to the electrical printed circuit board, and at least one second contacting portion, which is elastic in the lateral direction, for electrical and mechanical contacting of an inner lateral surface of an electrically conductive outer housing of the printed circuit board plug connector. The outer conductor contact element is able to establish an outer conductor attachment between the electrical printed circuit board and the outer housing of the printed circuit board plug connector. The outer conductor connection element can preferably be attached to an electrically insulating contact carrier of the printed circuit board plug connector, which is accommodated at least in portions in the outer housing, or can be supported at least laterally on said contact carrier. Preferably, the outer conductor contact element is a one-piece component that is independent of the outer housing. The further features described in the present description relate to advantageous embodiments and variants of this outer conductor connection element, which is preferably the outer conductor connection element already mentioned above.

In the following, exemplary embodiments of the invention are described in greater detail with reference to the drawings.

The figures each show preferred exemplary embodiments in which individual features of the present invention are shown in combination with one another. Features of an exemplary embodiment can also be implemented separately from the other features of the same exemplary embodiment and can accordingly be readily combined by a person skilled in the art to form further useful combinations and sub-combinations with features of other exemplary embodiments.

In the figures, elements with the same function are labelled with the same reference signs.

The figures show schematically:

FIG. 1 a perspective view of a printed circuit board plug connector according to a first exemplary embodiment of the invention;

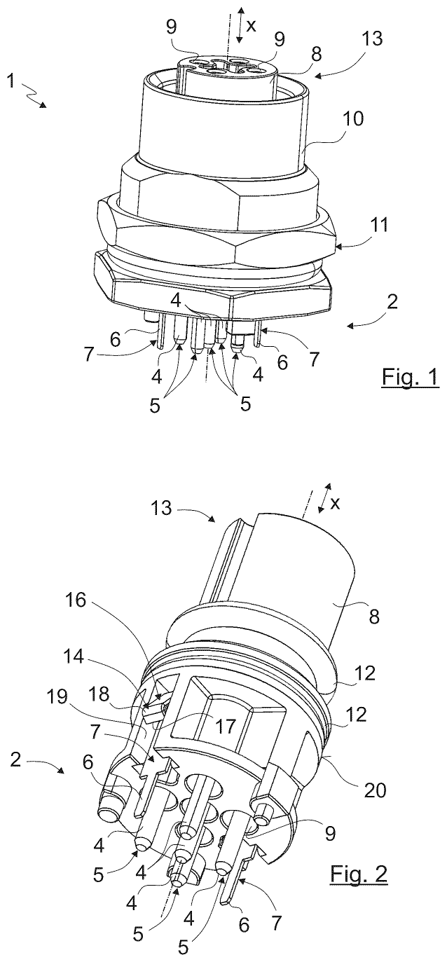

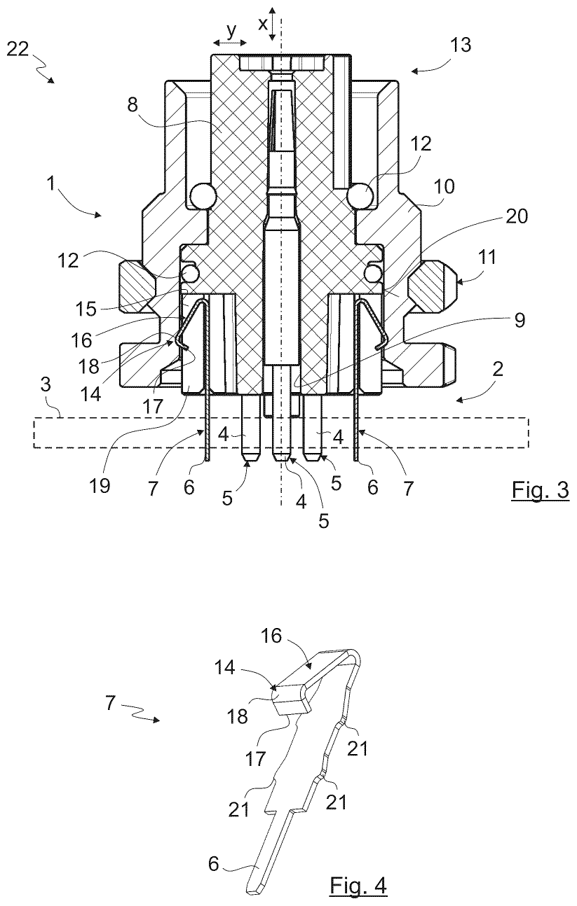

FIG. 2 another perspective view of the printed circuit board plug connector shown in FIG. 1 without its outer housing;

FIG. 3 a cross-sectional view of the printed circuit board plug connector according to FIG. 1;

FIG. 4 a perspective isolated view of one of the outer conductor connection elements of the printed circuit board plug connector according to FIG. 1;

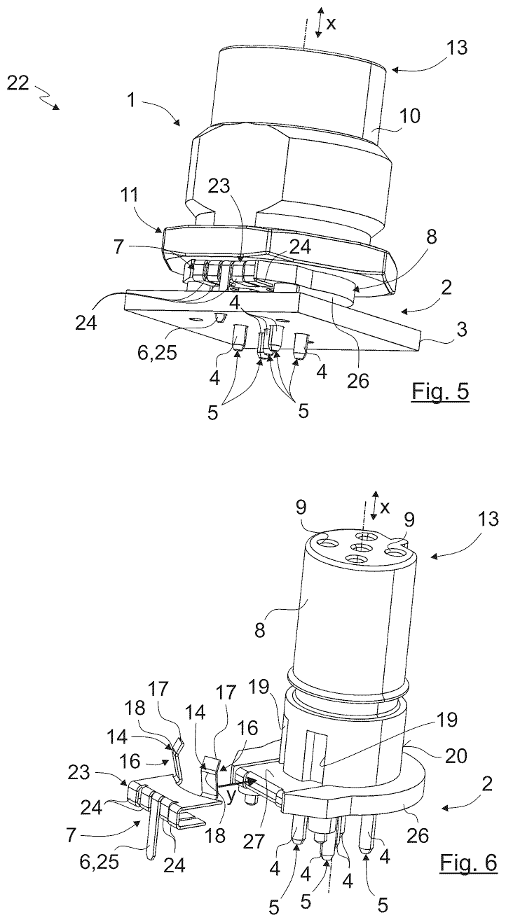

FIG. 5 a perspective view of a printed circuit board assembly formed of an electrical printed circuit board and a printed circuit board plug connector according to a second exemplary embodiment of the invention;

FIG. 6 a further perspective view of the printed circuit board plug connector of the printed circuit board assembly of FIG. 5 without its outer housing in an unmounted state of the outer conductor connection element; and

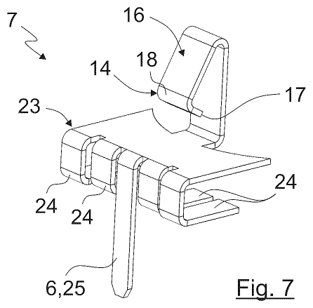

FIG. 7 an isolated view of an outer conductor connection element according to a further exemplary embodiment of the invention.

FIGS. 1 to 4 show a first exemplary embodiment of the invention. The printed circuit board plug connector 1 shown as an example has a first interface 2 for electrical and mechanical connection to an electrical printed circuit board 3 (see dashed lines in FIG. 3). For electrical and mechanical connection to the electrical printed circuit board 3, contact portions 4 of various electrical contact elements 5 and the first contacting portions 6 of the outer conductor connection elements 7, also mentioned below, are arranged in the first interface 2. The first interface 2 also has various mechanical connection means, such as spacer elements, feet, mechanical coding means and the like (partially recognisable in the figures, but not described in more detail).

The printed circuit board plug connector 1 shown in the exemplary embodiments is an example of a circular plug connector, although this is not to be understood as restrictive.

The printed circuit board plug connector 1 can have any number of electrical contact elements 5, for example just one electrical contact element 5. The figures show purely exemplary multi-pole printed circuit board plug connectors 1.

The electrical contact elements 5 are fastened in a dielectric contact carrier 8 and are interlocked or secured in axial direction x (see in particular FIG. 3). To accommodate the contact elements 5, the contact carrier 8 has respective contact chambers 9 for the individual contact elements 5. In this way, the contact elements 5 are spaced apart from each other and from the outer conductor connection element 7 and are thus also electrically insulated from each other.

The contact carrier 8 is accommodated, at least in portions, in an electrically conductive outer housing 10, which is sleeve-shaped or hollow-cylindrical in the exemplary embodiments. The outer housing 10 can in particular have mechanical connection interfaces 11 on the outer lateral surface side, such as the metric screw connection shown in the figures (in particular an external thread on the outer lateral surface of the outer housing and a screw nut that can be screwed onto it).

Optional sealing elements can be provided between the contact carrier 8 and the outer housing 10 (see, for example, the sealing rings 12 shown in FIG. 3).

The printed circuit board plug connector 1 has a second interface 13, different from the first interface 2, for electrical and mechanical connection to a corresponding mating plug connector (not shown). As an alternative to the indicated second interface 13 in the form of a plug-in interface for connection to a mating plug connector, the second interface 13 can also be designed for connection to a further electrical printed circuit board, another electrical assembly or for direct connection to an electrical cable (the contact elements 5 can then, for example, be connected directly to the electrical inner conductors of the electrical cable, for example crimped, soldered or welded).

At this point, it should be emphasized once again that the actual plug connector type and thus, in particular, the design of the first interface 2 and the second interface 13 as well as the geometric details of the printed circuit board plug connector 1 are not necessarily important in the context of the invention. Accordingly, the design shown in the figures is to be understood as merely exemplary.

The printed circuit board plug connector 1 has the outer conductor connection element 7 already mentioned above, which enables an electrical outer conductor transfer between the electrical printed circuit board 3 and the outer housing 10 of the printed circuit board plug connector 1. In the exemplary embodiments, the outer conductor connection element 7 is a one-piece component, for example a stamped and bent part.

The outer conductor connection element 7 has at least one first contacting portion 6 arranged in the first interface 2 of the printed circuit board plug connector 1 for electrical and mechanical connection to the electrical printed circuit board 3. Said first contacting portion 6 is preferably arranged on a first end portion of the outer conductor connection element 7. In the exemplary embodiments, the first contacting portion 6 is designed as a contact pin, which can be suitable for a press and/or solder connection with the electrical printed circuit board 3, for example.

The outer conductor connection element 7 also has at least one second contacting portion 14, which is elastic in the lateral direction y (see FIG. 3) or in the radial direction, for making electrical and mechanical contact with an inner lateral surface 15 of the outer housing 10 (see FIG. 3). The second contacting portion 14 of the outer conductor connection element 7 is preferably formed on a spring tab 16 that is elastic in the lateral direction y, which is able to make point or line contact with the inner lateral surface 15 of the outer housing 10. In an advantageous embodiment, a free end 17 of the spring tab 16 can be bent away from the inner lateral surface 15 of the outer housing 10, so that the spring tab 16 does not contact the inner lateral surface 15 of the outer housing 10 in the assembled state with the free end 17, but with a contact region 18 spaced from the free end 17 (cf. in particular the combined view of FIGS. 3 and 4). The outer housing 10 can thus be mounted on the contact carrier 8 fitted with the outer conductor connection elements 7 in a particularly gentle and simple manner.

In principle, a plurality of outer conductor connection elements 7 can be arranged distributed along the circumference of the contact carrier 8, preferably distributed equidistantly along the circumference. In the exemplary embodiment of FIGS. 1 to 4, two outer conductor connection elements 7 are provided on opposite sides of the printed circuit board plug connector 1 as an example, although this is to be understood merely as an example. In principle, a single outer conductor connection element 7 may be sufficient or, if necessary, more than two outer conductor connection elements 7 may be provided.

It has proven to be advantageous if the at least one outer conductor connection element 7 is accommodated, at least in portions, in a recess 19 of the contact carrier 8. In the exemplary embodiments, the outer conductor connection element 7 is accommodated in a laterally accessible fastening groove 19 within the outer lateral surface 20 of the contact carrier 8. In this way, the outer conductor connection element 7 can be particularly easily accessed from the side for contacting the outer housing 10.

For a captive fastening, particularly in the axial direction x, the at least one outer conductor connection element 7 and the contact carrier 8 can form one or more latching connections for mutual latching. Corresponding latching elements 21 of the outer conductor connection element 7 are clearly recognizable in FIG. 4, for example. Lateral securing of the outer conductor connection element 7 on the contact carrier 8 can also be provided, for example if the recess 19 in the contact carrier 8 is T-slot-shaped to accommodate the outer conductor connection element 7, as clearly recognizable in FIG. 2. However, lateral securing of the outer conductor connection element 7 in particular can also be omitted if necessary, as this can in principle already be secured laterally by the outer housing 10 itself, at least when the outer housing 10 is in the mounted state.

A further exemplary embodiment of the invention is illustrated in FIGS. 5 and 6. The second exemplary embodiment is fundamentally similar to the first exemplary embodiment, which is why fundamentally only the differences will be discussed below.

FIG. 5 shows a printed circuit board assembly 22 comprising an electrical printed circuit board 3 and a printed circuit board plug connector 1, which has an outer conductor connection element 7 according to a further variant of the invention. For better visualization, the printed circuit board plug connector 1 of FIG. 5 is shown in FIG. 6 without the outer housing 10 and in an unmounted state of the outer conductor connection element 7.

The outer conductor connection element 7 shown in FIGS. 5 and 6 has a fastening clamp 23 spaced from the first contacting portion 6 and the second contacting portion 14, with which the outer conductor connection element 7 can be fastened in a frictionally engaged manner to the contact carrier 8. The fastening clamp 23 is arranged between the first contacting portion 6 and the second contacting portion 14 and has a plurality of fastening fingers 24 for frictionally engaged fastening. A contact pin 25, which forms the first contacting portion 6 of the outer conductor connection element 7, runs between each two of the fastening fingers 24 (basically, this is another fastening finger that has not been reshaped for frictionally engaged fastening).

The fastening clamp 23 is able to laterally clamp around a lateral elevation 26 of the contact carrier 8 (in the exemplary embodiment, a fastening flange 26) in a frictionally engaged manner. The fastening flange 26 has a recess 27 for the fastening clamp 23 for improved fastening (see FIG. 6). Optionally, when using an outer conductor connection element 7 with a fastening clamp 23, an additional latching connection can be provided for latching to the contact carrier 8 (not shown).

The exemplary embodiment in FIGS. 5 and 6 is also intended to illustrate that the outer conductor connection element 7 may also have a plurality of second contacting portions 14 for contacting the inner lateral surface 15 of the outer housing 10. In the exemplary embodiment, two spring tabs 16 are provided, which in turn are accommodated in corresponding elongate recesses 19 or fastening grooves 19 in the outer lateral surface 20 of the contact carrier 8.

However, an outer conductor connection element 7 having a fastening clamp 23 can in principle also be formed in the second contacting portion 14 in a similar way to the outer conductor connection element 7 proposed in the first exemplary embodiment, which is to be illustrated by means of the exemplary embodiment shown in FIG. 7.

At this point, it should also be mentioned that when using a fastening clamp 23, it is not absolutely necessary for it to embrace a lateral elevation 26 of the contact carrier 8. In principle, an inverse arrangement can also be provided, in which the fastening clamp 23 is introduced in a frictionally engaged manner into a recess in the contact carrier 8, preferably in a laterally accessible fastening groove within the outer lateral surface 20 of the contact carrier 8. The fastening clamp 23 can then spread out within the recess and be supported on opposite side walls of the recess (not shown in the figures).

1. A printed circuit board plug connector comprising:
a first interface configured to electro-mechanically connect to an electrical printed circuit board;
an electrically conductive outer housing;
an electrically insulating contact carrier for an at least one electrical contact element, wherein the contact carrier is accommodated at least in portions in the outer housing; and
an at least one outer conductor connection element fastened to the contact carrier,
wherein the outer conductor connection element includes
(i) an at least one first contacting portion arranged in the first interface for an electro-mechanical connection to the electrical printed circuit board, and
(ii) an at least one second contacting portion, which is elastic in a lateral direction (y), the at least one second contacting portion electro-mechanically contacting an inner lateral surface of the outer housing.

2. The printed circuit board plug connector of claim 1,
wherein the at least one outer conductor connection element is accommodated at least partially in a recess of the contact carrier.

3. The printed circuit board plug connector of claim 1,
wherein the at least one outer conductor connection element includes an at least one fastening clamp spaced apart from the first contacting portion and from the second contacting portion, and
wherein the at least fastening clamp is configured to fasten the outer conductor connection element to the contact carrier in a frictionally engaged manner.

4. The printed circuit board plug connector of claim 3,
wherein the at least one fastening clamp either
a) clamps around a lateral elevation of the contact carrier in a laterally frictionally engaged manner; or
b) is situated in a frictionally engaged manner in a recess in the contact carrier.

5. The printed circuit board plug connector of claim 1,
wherein the at least one outer conductor connection element and the contact carrier form an at least one latching connection for mutual latching.

6. The printed circuit board plug connector of claim 1,
wherein the first contacting portion of the outer conductor connection element is a contact pin.

7. The printed circuit board plug connector of claim 1,
wherein the second contacting portion of the outer conductor connection element is designed as a spring tab that is elastic in the lateral direction (y).

8. The printed circuit board plug connector of claim 7,
wherein the spring tab includes a free end and a contact region spaced apart from the free end, and
wherein the free end of the spring tab is bent pointing away from the inner lateral surface of the outer housing, so that the spring tab contacts the inner lateral surface of the outer housing with the contact region, without contacting the outer housing with the free end.

9. The printed circuit board plug connector of claim 1,
wherein the at least one outer conductor connection element a one-piece component.

10. The printed circuit board plug connector of claim 1,
wherein the at least one outer conductor connection element comprises a plurality of outer conductor connection elements arranged distributed along a circumference of the contact carrier.

11. The printed circuit board plug connector of claim 1,
wherein the at least one outer conductor connection element is arranged at least partially along the circumference of the contact carrier.

12. The printed circuit board plug connector of claim 1,
wherein the at least one electrical contact element is fastened in the contact carrier and spaced from the at least one outer conductor connection element.

13. The printed circuit board plug connector of claim 1,
comprising a second interface, different from the first interface, for an electro-mechanical connection to i) a corresponding mating plug connector, ii) to a further electrical printed circuit board, or iii) to an electrical cable.

14. A printed circuit board assembly, comprising;
an electrical printed circuit board; and
a printed circuit board plug connector including
a) a first interface electro-mechanically connected to the electrical printed circuit board;
b) an electrically conductive outer housing;
c) an electrically insulating contact carrier for an at least one electrical contact element, wherein the contact carrier is at least partially accommodated in the outer housing; and
d) an at least one outer conductor connection element fastened to the contact carrier, wherein the outer conductor connection element includes
(i) an at least one first contacting portion arranged in the first interface, the at least one first contacting portion electro-mechanically connected to the electrical printed circuit board, and
(ii) an at least one second contacting portion, which is elastic in the lateral direction (y), the at least one second contacting portion electro-mechanically contacting an inner lateral surface of the outer housing.

15. A method for assembling a printed circuit board plug connector designed to electro-mechanically connect to an electrical printed circuit board, said method comprising the steps of:
providing an electrically insulating contact carrier configured to receive an at least one electrical contact element;
providing an at least one outer conductor connection element having a) an at least one first contacting portion for an electro-mechanical connection to the electrical printed circuit board, and b) an at least one second contacting portion that is elastic in a lateral direction (y);
fastening the at least one outer conductor connection element to the contact carrier;
providing an outer housing; and
mounting the outer housing on the contact carrier, so that the at least one second contacting portion of the at least one outer conductor connection element makes an electro-mechanical contact with an inner lateral surface of the outer housing.

16. The printed circuit board plug connector of claim 2, wherein the at least one outer conductor connection element is accommodated in the recess of the contact carrier in a laterally accessible fastening groove within an outer lateral surface of the contact carrier.

17. The printed circuit board plug connector of claim 3, wherein the at least one fastening clamp is arranged between the fist contacting portion and the second contacting portion.

18. The printed circuit board plug connector of claim 4, wherein the lateral elevation of the contact carrier is a fastening flange or a fastening web.

19. The printed circuit board plug connector of claim 6, wherein the contact pin is configured for an at least one of i) a press connection to the electrical printed circuit board, ii) a solder connection to the electrical printed circuit board, and iii) a combination thereof.

20. The printed circuit board plug connector of claim 7, wherein the spring tab makes i) a point contact with the inner lateral surface of the outer housing, or ii) a line contact with the inner lateral surface of the outer housing.
